(19) United States
(12) Patent Application Publication
(10) Pub. No.: US 2025/0039803 A1
(43) Pub. Date: Jan. 30, 2025

(54) TRANSMIT POWER DETERMINING METHOD AND APPARATUS, TERMINAL, NETWORK SIDE DEVICE, AND STORAGE MEDIUM

(71) Applicant: VIVO MOBILE COMMUNICATION CO., LTD., Dongguan (CN)

(72) Inventors: Xiaohang CHEN, Dongguan (CN); Xueming PAN, Dongguan (CN)

(73) Assignee: VIVO MOBILE COMMUNICATION CO., LTD., Dongguan (CN)

(21) Appl. No.: 18/912,558

(22) Filed: Oct. 10, 2024

Related U.S. Application Data
(63) Continuation of application No. PCT/CN2023/087515, filed on Apr. 11, 2023.

(30) Foreign Application Priority Data
Apr. 11, 2022 (CN) 202210375459.4

(51) Int. Cl. H04W 52/14; H04W 72/0453

(52) U.S. Cl. CPC H04W 52/146; H04W 72/0453

(57) ABSTRACT

This application discloses a transmit power determining method and apparatus, a terminal, and a network side device. The transmit power determining method includes: receiving, by a terminal, L pieces of configuration information sent by a network side device; and determining, by the terminal based on the L pieces of configuration information, a transmit power for performing uplink transmission on a target uplink resource. The L pieces of configuration information include first power control configuration information and/or at least one piece of second power control configuration information, and L is greater than or equal to 1. The first power control configuration information is used to determine a transmit power of the terminal for performing uplink transmission on a first uplink resource. Each piece of the second power control configuration information is used to determine a transmit power of the terminal for performing uplink transmission on a second uplink resource.

### CROSS-REFERENCE TO RELATED APPLICATIONS

This application is a continuation of International Application No. PCT/CN 2023/087515, filed on Apr. 11, 2023, which claims priority to Chinese Patent Application No. 202210375459.4, filed on Apr. 11, 2022. The entire contents of each of the above-referenced applications are expressly incorporated herein by reference.

### TECHNICAL FIELD

This application pertains to the field of communication technologies, and in particular, to a transmit power determining method and apparatus, a terminal, a network side device, and a storage medium.

### BACKGROUND

In the mobile communication system, transmission modes of uplink and downlink data usually include Frequency Division Duplex (FDD), Time Division Duplex (TDD), Half duplex (HD), Full Duplex (FD), and the like. For a symmetric spectrum of FDD, an uplink spectrum or a downlink spectrum of FDD may be semi-statically configured or dynamically indicated as downlink transmission or uplink transmission on some slots/symbols; for an asymmetric spectrum of TDD, different frequency domain resources of TDD on some slots/symbols may be semi-statically configured or dynamically indicated as both uplink transmission and downlink transmission; for a device of HD, only uplink sending or downlink reception can be performed at the same time, that is, the device cannot receive and send signals at the same time; and for a device of FD, the device may use same frequency band transmission for uplink sending or downlink reception at the same time.

At present, in the New radio (NR) system, when a base station operates in an FD mode, there is a case in which downlink data is sent to a 1^{st} terminal on a frequency domain resource of a time t, and uplink data sent by a 2^{nd} terminal is received at the same time.

However, when receiving the uplink data sent by the 2^{nd} terminal, the base station may be affected by the downlink data sent by the base station to the 1^{st} terminal. This effect may be usually offset by increasing a transmit power of the terminal for uplink transmission. However, there is no specific technical solution to determine the transmit power of the terminal for uplink transmission, resulting in low uplink transmission performance between the base station and the terminal.

### SUMMARY

Embodiments of this application provide a transmit power determining method and apparatus, a terminal, a network side device, and a storage medium.

According to a first aspect, a transmit power determining method is provided, including:
receiving, by a terminal, L pieces of configuration information sent by a network side device, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; and each piece of the second power control configuration information is used to determine a transmit power of the terminal for performing uplink transmission on a second uplink resource; and
determining, by the terminal based on the L pieces of configuration information, a transmit power for performing uplink transmission on a target uplink resource.

According to a second aspect, a transmit power determining method is provided, including:
sending, by a network side device, L pieces of configuration information to a terminal, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the L pieces of configuration information indicate the terminal to determine a transmit power for performing uplink transmission on a target uplink resource.

According to a third aspect, a transmit power determining apparatus is provided, including:
a receiving module, configured to receive L pieces of configuration information sent by a network side device, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; and each piece of the second power control configuration information is used to determine a transmit power of the terminal for performing uplink transmission on a second uplink resource; and
a determining module, configured to determine, based on the L pieces of configuration information, a transmit power for performing uplink transmission on a target uplink resource.

According to a fourth aspect, a transmit power determining apparatus is provided, including:
a sending module, configured to send L pieces of configuration information to a terminal, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the L pieces of configuration information indicate the terminal to determine a transmit power for performing uplink transmission on a target uplink resource.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The communication interface is configured to receive L pieces of configuration information sent by a network side device, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the processor is configured to determine, based on the L pieces of configuration information, a transmit power for performing uplink transmission on a target uplink resource.

According to a seventh aspect, a network side device is provided. The network side device includes a processor and a memory, the memory stores a program or an instruction that can be run on the processor, and the program or the instruction is executed by the processor to implement the steps of the method according to the second aspect.

According to an eighth aspect, a network side device is provided, including a processor and a communication interface. The communication interface is configured to send L pieces of configuration information to a terminal, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the L pieces of configuration information indicate the terminal to determine a transmit power for performing uplink transmission on a target uplink resource.

According to a ninth aspect, a transmit power determining system is provided, including a terminal and a network side device. The terminal may be configured to perform the steps of the method according to the first aspect, and the network side device may be configured to perform the steps of the method according to the second aspect.

According to a tenth aspect, a readable storage medium is provided, where the readable storage medium stores a program or an instruction, and when the program or the instruction is executed by a processor, the steps of the method according to the first aspect or the steps of the method according to the second aspect are implemented.

According to an eleventh aspect, a chip is provided. The chip includes a processor and a communication interface, the communication interface is coupled to the processor, and the processor is configured to run a program or an instruction to implement the method according to the first aspect or the second aspect.

According to a twelfth aspect, a computer program/program product is provided, where the computer program/program product is stored in a storage medium, and the computer program/program product is executed by at least one processor to implement the steps of the method according to the first aspect or the second aspect.

In the embodiments of this application, the terminal receives L pieces of configuration information sent by the network side device, where the configuration information includes first power control configuration information used to determine a transmit power of the terminal for performing uplink transmission on a first uplink resource and/or at least one piece of second power control configuration information used to determine a transmit power of the terminal for performing uplink transmission on a second uplink resource. Then the terminal may determine, based on the configuration information, the transmit power for uplink transmission on the target uplink resource. The terminal receives different power control configuration information configured by the network side device for the first uplink resource and the second uplink resource, so that the transmit power suitable for performing uplink transmission on the target uplink resource may be determined based on the different power control configuration information, thereby effectively improving uplink transmission performance between the network side device and the terminal.

### BRIEF DESCRIPTION OF DRAWINGS

FIG. 1 is a schematic diagram of a wireless communication system to which embodiments of this application can be applied;

FIG. 2 is a first schematic flowchart of a transmit power determining method according to an embodiment of this application;

FIG. 3 is a schematic diagram of a location relationship between different second uplink resources and a frequency domain resource unit in a transmission format of DL according to an embodiment of this application;

FIG. 4 is a second schematic flowchart of a transmit power determining method according to an embodiment of this application;

FIG. 5 is a third schematic flowchart of a transmit power determining method according to an embodiment of this application;

FIG. 6 is a fourth schematic flowchart of a transmit power determining method according to an embodiment of this application;

FIG. 7 is a schematic diagram of signaling interaction of a transmit power determining method according to an embodiment of this application;

FIG. 8 is a first schematic diagram of a relationship between frequency domain locations of different frequency domain resource units and a transmit power for uplink transmission according to an embodiment of this application;

FIG. 9 is a second schematic diagram of a relationship between frequency domain locations of different frequency domain resource units and a transmit power for uplink transmission according to an embodiment of this application;

FIG. 10 is a first schematic diagram of a structure of a transmit power determining apparatus according to an embodiment of this application;

FIG. 11 is a second schematic diagram of a structure of a transmit power determining apparatus according to an embodiment of this application;

FIG. 12 is a schematic diagram of a structure of a communication device according to an embodiment of this application;

FIG. 13 is a schematic diagram of a structure of a terminal according to an embodiment of this application; and

FIG. 14 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following descriptions describe a NR system for example purposes, and NR terms are used in most of the following descriptions, but these technologies can also be applied to a communication system other than an NR system application, for example, a 6th Generation (6G) communication system.

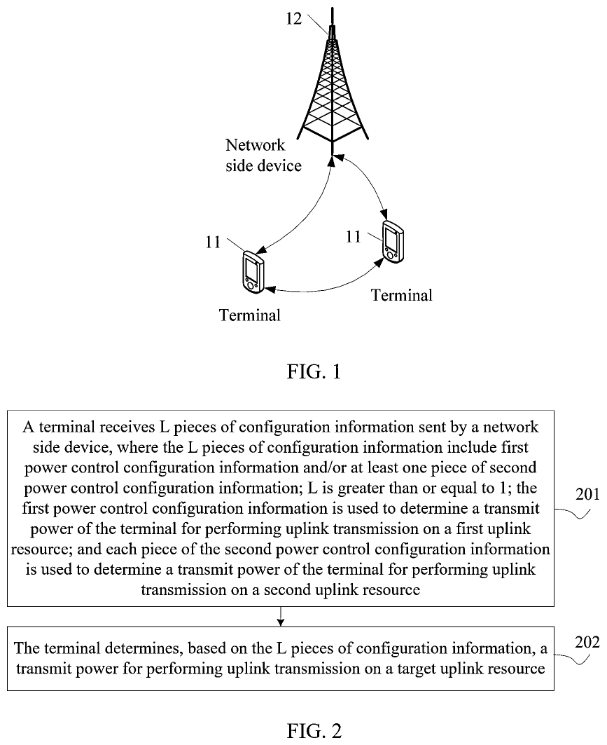

FIG. 1 is a schematic diagram of a wireless communication system to which embodiments of this application can be applied. The wireless communication system shown in FIG. 1 includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a Personal Computer (PC), a teller machine, or a self-service machine, and the wearable device includes a smart watch, a smart band, smart carphones, smart glasses, smart jewelry (a smart bracelet, a smart hand chain, a smart ring, a smart necklace, a smart bangle, a smart anklet, or the like), a smart wristband, smart clothes, and the like. It should be noted that a specific type of the terminal 11 is not limited in the embodiments of this application.

The network side device 12 may include an access network device or a core network device. The access network device may also be referred to as a radio access network device, a Radio Access Network (RAN), a radio access network function, or a radio access network unit. The access network device may include a base station, a WLAN access node, a Wi-Fi node, or the like. The base station may be referred to as a NodeB, an evolved NodeB (CNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. As long as a same technical effect is achieved, the base station is not limited to a specified technical term. It should be noted that, in the embodiments of this application, only a base station in an NR system is used as an example for description, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), Unified Data Repository (UDR), a Home Subscriber Server (HSS), a Centralized network configuration (CNC), a Network Repository Function (NRF), a Network Exposure Function (NEF), a local NEF (L-NEF), a Binding Support Function (BSF), an Application Function (AF), a Location Manage Function (LMF), an Enhanced Serving Mobile Location Centre (E-SMLC), a Network Data Analytics Function (NWDAF), and the like. It should be noted that, in the embodiments of this application, only a core network device in an NR system is used as an example for description, and a specific type of the core network device is not limited.

At present, in the NR system, when operating in an FD mode, a base station may be affected by downlink data sent by the base station to a 1^{st} terminal in a case of receiving uplink data sent by a 2^{nd} terminal. This effect may be usually offset by increasing a transmit power of the terminal for uplink transmission. However, in the current NR system, interference caused by a co-channel and/or an adjacent channel is not considered, and the transmit power required for uplink transmission cannot be determined based on a transmission format, such as a transmission format of uplink (UL), downlink (DL), or flexible, resulting in low uplink transmission performance between the base station and the terminal.

With reference to the accompanying drawings, a transmit power determining method provided in the embodiments of this application is described in detail by using some embodiments and application scenarios thereof.

The transmit power determining method provided in the embodiments of this application may be applied to a terminal 11, so that the terminal determines a transmit power for performing uplink transmission on a target uplink resource.

FIG. 2 is a first schematic flowchart of a transmit power determining method according to an embodiment of this application. As shown in FIG. 2, the method includes step 201 and step 202.

Step 201: A terminal receives L pieces of configuration information sent by a network side device, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; and each piece of the second power control configuration information is used to determine a transmit power of the terminal for performing uplink transmission on a second uplink resource.

Step 202: The terminal determines, based on the L pieces of configuration information, a transmit power for performing uplink transmission on a target uplink resource.

It should be noted that this embodiment of this application may be applied to a terminal. When performing uplink transmission with a network side device such as a base station, the terminal may be interfered by downlink transmission between the network side device and other terminals. In this case, the network side device may indicate the terminal to increase the transmit power for uplink transmission, to reduce the above interference.

In this embodiment of this application, the terminal receives L pieces of configuration information sent by the network side device, where the configuration information includes first power control configuration information used to determine a transmit power of the terminal for performing uplink transmission on a first uplink resource and/or at least one piece of second power control configuration information used to determine a transmit power of the terminal for performing uplink transmission on a second uplink resource. Then the terminal may determine, based on the configuration information, the transmit power for uplink transmission on the target uplink resource. The terminal receives different power control configuration information configured by the network side device for the first uplink resource and the second uplink resource, so that the transmit power suitable for performing uplink transmission on the target uplink resource may be determined based on the different power control configuration information, thereby effectively improving uplink transmission performance between the network side device and the terminal.

In some embodiments, the terminal receives Radio Resource Control (RRC) signaling sent by the network side device, where the RRC signaling includes the L pieces of configuration information.

In some embodiments, the first uplink resource and the second uplink resource may be any one of the following resources:
(1) a time domain resource/frequency domain resource configured or indicated by a network; and
(2) a resource corresponding to a specific uplink transmission channel/uplink transmission signal configured or indicated by a network.

The uplink transmission channel is, for example, a Physical Uplink Control Channel (PUCCH) or a Physical Uplink Shared Channel (PUSCH), and the uplink transmission signal is, for example, a Sounding Reference Signal (SRS).

In some embodiments, the first uplink resource has no co-channel interference and/or adjacent channel interference, and the second uplink resource has co-channel interference and/or adjacent channel interference.

For example, based on the L pieces of configuration information, the terminal may determine, in a case that the target uplink resource belongs to the first uplink resource, that the transmit power for uplink transmission on the target uplink resource is P1; and in a case that the target uplink resource belongs to the second uplink resource, it is determined that the transmit power for uplink transmission on the target uplink resource is P2. Because the terminal needs to increase the transmit power for uplink transmission, to reduce the co-channel interference and/or the adjacent channel interference, it may be set that P2>P1.

In some embodiments, a frequency domain resource unit of the first uplink resource satisfies at least one of the following:
(1) the frequency domain resource unit of the first uplink resource does not overlap with any frequency domain resource unit in a transmission format of DL or flexible;
(2) a frequency domain interval between the frequency domain resource unit of the first uplink resource and any frequency domain resource unit in a transmission format of DL or flexible is greater than or equal to N frequency domain resource units, where N is greater than 0, and N may be configured or indicated by a network or predefined; and
(3) a frequency domain interval between a center frequency of the first uplink resource and a center frequency of a frequency domain resource unit in a transmission format of DL or flexible is greater than or equal to N1 frequency domain resource units, where N1 is greater than 0, and N1 may be configured or indicated by a network or predefined, where
a quantity or a granularity of the frequency domain resource unit of the first uplink resource is the same as or different from a quantity or a granularity of a frequency domain resource unit in a transmission format of DL or flexible.

Specifically, the frequency domain resource unit in a transmission format of DL or flexible may belong to a current cell or other cells, such as neighboring cells. To be specific, the considered co-channel interference and/or adjacent channel interference may be intra-cell or inter-cell.

In some embodiments, the transmission format includes a frequency domain transmission format or a time domain transmission format.

It should be noted that the frequency domain resource unit in a transmission format of DL is used to transmit downlink data; a frequency domain resource unit in a transmission format of flexible may be rewritten as a frequency domain resource unit in a transmission format of UL or DL, and in a case of being rewritten as a frequency domain resource unit in a transmission format of UL, the frequency domain resource unit is used to transmit uplink data; and in a case of being rewritten as a frequency domain resource unit in a transmission format of DL, the frequency domain resource unit is used to transmit downlink data.

The frequency domain resource unit includes at least one of the following:
(1) a frequency domain sub-band;
(2) a Resource Block (RB); and
(3) a Bandwidth Part (BWP).

In some embodiments, a frequency domain resource unit of the second uplink resource satisfies at least one of the following:
(1) the frequency domain resource unit of the second uplink resource overlaps with a frequency domain resource unit in a transmission format of DL or flexible;
(2) the frequency domain resource unit of the second uplink resource does not overlap with a frequency domain resource unit in a transmission format of DL or flexible, and a frequency domain interval between the frequency domain resource unit of the second uplink resource and a frequency domain resource unit in a transmission format of DL or flexible is less than or equal to M frequency domain resource units, where M is greater than 0, and M may be configured or indicated by a network or predefined; and
(3) the frequency domain resource unit of the second uplink resource does not overlap with a frequency domain resource unit in a transmission format of DL or flexible, and a frequency domain interval between a center frequency of the second uplink resource and a center frequency of a frequency domain resource unit in a transmission format of DL or flexible is less than or equal to M1 frequency domain resource units, where M1 is greater than 0, and M1 may be configured or indicated by a network or predefined, where
a quantity or a granularity of the frequency domain resource unit of the second uplink resource is the same as or different from a quantity or a granularity of a frequency domain resource unit in a transmission format of DL or flexible.

Specifically, the frequency domain resource unit in a transmission format of DL or flexible may belong to a current cell or other cells, such as neighboring cells. To be specific, the considered co-channel interference and/or adjacent channel interference may be intra-cell or inter-cell.

In some embodiments, the second power control configuration information is related to at least one of the following:
(1) a frequency domain interval between the frequency domain resource unit of the second uplink resource and a frequency domain resource unit in a transmission format of DL or flexible; and
(2) a quantity of frequency domain resource units in a transmission format of DL or flexible and with a frequency domain interval from the frequency domain resource unit of the second uplink resource less than or equal to M frequency domain resource units.

In some embodiments, different second power control configuration information corresponds to different degrees of co-channel interference and/or adjacent channel interference existing in the second uplink resource; and different second power control configuration information is used to determine different transmit powers.

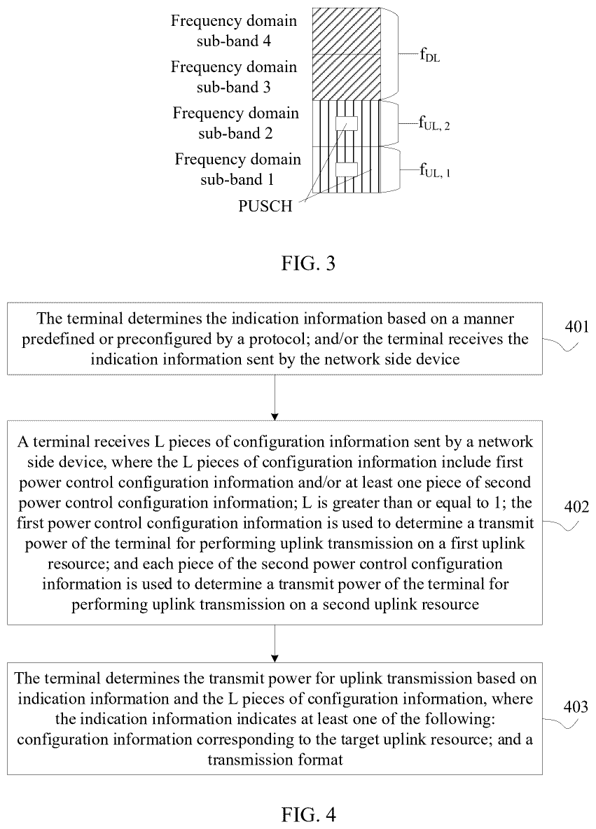

For example, FIG. 3 is a schematic diagram of a location relationship between different second uplink resources and a frequency domain resource unit in a transmission format of DL. Refer to FIG. 3, an example in which the frequency domain resource unit is a frequency domain sub-band is used for description.

Frequency domain sub-band 3 and frequency domain sub-band 4 are frequency domain resource units in a transmission format of DL, frequency domain sub-band 1 and frequency domain sub-band 2 are frequency domain resource units in a transmission format of UL, and frequency domain sub-band 1 and frequency domain sub-band 2 are provided with a PUSCH.

It can be seen from the figure that frequency domain sub-band 1 and frequency domain sub-band 2 are configured to be adjacent, frequency domain sub-band 2 and frequency domain sub-band 3 are configured to be adjacent, and frequency domain sub-band 3 and frequency domain sub-band 4 are configured to be adjacent. Compared with a frequency domain interval between frequency domain sub-band 1 and frequency domain sub-band 3, a frequency domain interval between frequency domain sub-band 2 and frequency domain sub-band 3 is smaller, so it can be considered that frequency domain sub-band 2 suffers more adjacent channel interference than frequency domain sub-band 1. In this case, frequency domain sub-band 2 may be configured to correspond to one second power control configuration information, and frequency domain sub-band 1 is configured to correspond to another second power control configuration information. Some parameters of these two pieces of second power control configuration information may be the same, and some parameters thereof may be different, for example, a transmit power included in the second power control configuration information corresponding to frequency domain sub-band 2 may be greater than a transmit power included in the second power control configuration information corresponding to frequency domain sub-band 1.

In addition, adjacent channel interference that frequency domain sub-band 1 and frequency domain sub-band 2 separately suffers may also be compared in another manner. In FIG. 3, a center frequency of frequency domain sub-band 3 and frequency domain sub-band 4 is f_{DL}, a center frequency of frequency domain sub-band 1 is f_{UL, 1}, and a center frequency of frequency domain sub-band 2 is f_{UL, 2}. Therefore, compared with a frequency domain interval between f_{UL, 1} and f_{DL}, a frequency domain interval between f_{UL, 2} and f_{DL} is smaller, so it can be considered that frequency domain sub-band 2 suffers more adjacent channel interference than frequency domain sub-band 1.

In some embodiments, the configuration information includes at least one of the following power control parameters.

### (1) Target Transmit Power P0.

In some embodiments, a target transmit power included in the first power control configuration information may be smaller than a target transmit power included in the second power control configuration information.

In some embodiments, target transmit powers included in all second power control configuration information may be the same or different, and different target transmit powers are used to determine different co-channel interference and/or adjacent channel interference suffered by uplink transmission on different resources.

In some embodiments, different target transmit powers may be determined based on indicators related to co-channel interference and/or adjacent channel interference.

The indicators related to co-channel interference and/or adjacent channel interference are, for example, in-band emission, out of band emission, Adjacent Channel Selectivity (ACS) of a receiver, an Adjacent Channel Leakage Power Ratio (ACLR) of a transmitter, a frequency domain interval (NfreqGap) from a frequency domain resource unit in a transmission format of DL, and a frequency domain resource that is outside a frequency band for sending a signal and that is with a bandwidth of *U %.

### (2) Power Compensation Factor Alpha.

Specifically, Alpha is used to compensate for losses such as path loss by increasing a power, and Alpha is usually set between 0 and 1.

In some embodiments, Alpha included in the first power control configuration information may be smaller than Alpha included in the second power control configuration information.

In some embodiments, Alpha included in all second power control configuration information may be the same or different, and different Alpha is used to determine different co-channel interference and/or adjacent channel interference suffered by uplink transmission on different resources.

### (3) Path Loss (Pathloss) Parameter.

In some embodiments, Pathloss parameter includes a pathloss RS and a reference signal power.

In some embodiments, Pathloss parameter included in the first power control configuration information may be a pathloss RS transmitted on a resource without co-channel interference or adjacent channel interference; and Pathloss parameter included in the second power control configuration information may be a pathloss RS transmitted on a resource with co-channel interference or adjacent channel interference.

In some embodiments, different pathloss RSs and reference signal powers may be configured based on a resource location or an interference magnitude of existing co-channel interference or adjacent channel interference.

### (4) Power Control Loop.

In some embodiments, Power control loop included in the first power control configuration information may be the same as or different from Power control loop included in the second power control configuration information.

### (5) Transmission Power Control (TPR) Command.

In some embodiments, TPC command included in the first power control configuration information may be the same as or different from TPC command included in the second power control configuration information.

### (6) Power Control Offset.

In some embodiments, the power control offset is used to compensate for possible co-channel interference or adjacent channel interference.

It should be noted that power control parameter (1) to power control parameter (3) may be used for open-loop power control subsequently, and power control parameter (4) and power control parameter (5) may be used for closed-loop power control subsequently.

In some embodiments, the above power control parameters may be arbitrarily combined to form a power control parameter set, and the power control configuration information may include one or more power control parameter sets.

For example, power control configuration 1 includes 4 power control parameter sets, and each power control parameter set includes {P0, Alpha}; and power control configuration 2 includes 3 power control parameter sets, and each power control parameter set includes {P0, Alpha, pathloss}.

In some embodiments, the uplink transmission includes at least one of the following.
(1) Periodic uplink transmission or semi-persistent uplink transmission.

In some embodiments, the periodic uplink transmission or the semi-persistent uplink transmission is, for example:
an uplink Scheduling Request (SR), a Configured Grant (CG) PUSCH, Semi-Persistent Channel State Information (SP-CSI) on a PUSCH, SP-CSI on a PUCCH, a Persistent Sounding Reference Signal (P-SRS), a Semi-Persistent Sounding Reference Signal (SP-SRS), and a Physical Random Access Channel (PRACH).
(2) Dynamically scheduled uplink transmission.

In some embodiments, the dynamically scheduled uplink transmission is, for example, a PUSCH or a PUCCH scheduled by a network.

In some embodiments, in a case that the uplink transmission is repeated transmission, the terminal performs any one of the following operations:
(1) separately determining, by the terminal, a transmit power of each repetition based on the L pieces of configuration information and a resource in which each repetition is located; and
(2) determining, by the terminal, transmit powers of all repetitions based on the L pieces of configuration information and a resource in which a Y^{th} repetition is located, where Y is greater than or equal to 1.

In this embodiment of this application, the terminal receives different power control configuration information configured by the network side device for the first uplink resource and the second uplink resource, where the first uplink resource has no co-channel interference and/or adjacent channel interference, and the second uplink resource has co-channel interference and/or adjacent channel interference. On the basis of considering the co-channel interference and/or the adjacent channel interference, the terminal may determine transmit power suitable for performing uplink transmission on the target uplink resource based on the different power control configuration information, thereby effectively improving uplink transmission performance between the network side device and the terminal.

In some embodiments, FIG. 4 is a second schematic flowchart of a transmit power determining method according to an embodiment of this application. As shown in FIG. 4, step 402 is basically the same as step 201, but the difference is step 403.

Step 402: A terminal receives L pieces of configuration information sent by a network side device, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; and each piece of the second power control configuration information is used to determine a transmit power of the terminal for performing uplink transmission on a second uplink resource.

Step 403: The terminal determines the transmit power for uplink transmission based on indication information and the L pieces of configuration information, where the indication information indicates at least one of the following: configuration information corresponding to the target uplink resource; and a transmission format.

In some embodiments, the indication information for indicating the transmission format may be frequency domain format indication or time domain format indication.

In some embodiments, refer to FIG. 4, before step 402, the method further includes step 401.

Step 401: The terminal determines the indication information based on a manner predefined or preconfigured by a protocol; and/or the terminal receives the indication information sent by the network side device.

In some embodiments, the indication information includes at least one of the following:
(1) at least one resource set; and
(2) at least one power adjustment indication.

Each resource set includes at least one of the following.
(1) A time domain and/or frequency domain resource.

In some embodiments, the time domain and/or frequency domain resource is, for example, a number, a starting position, an end location, a length, and the like.
(2) A transmission format.

In some embodiments, the transmission format is, for example, DL, UL, and flexible.
(3) Target power control configuration information corresponding to the resource set.

In some embodiments, if the indication information does not indicate target power control configuration information corresponding to a specific resource set, a default power control configuration configured by RRC may be used as the target power control configuration information, or a power control configuration that receives a latest network indication is used as the target power control configuration information.
(4) An uplink channel or an uplink signal corresponding to the resource set.

In some embodiments, the uplink channel is, for example, a CG PUSCH, a PUCCH for SR, a PUCCH for Hybrid Automatic Repeat Request (HARQ), a PUCCH for CSI, and a PRACH.

In some embodiments, each uplink channel has a priority, such as a low priority or a high priority.

In some embodiments, the uplink signal is, for example, an SRS and SP-CSI on PUSCH.
(5) A frequency domain interval from at least one frequency domain resource unit in a transmission format of DL.
(6) A frequency domain interval from at least one frequency domain resource unit in a transmission format of flexible.
(7) A frequency domain interval between a center frequency of the resource set and a center frequency of a frequency domain resource unit in a transmission format of DL or flexible.

Each power adjustment indication includes at least one of the following.
(1) Target power control configuration information.
(2) An uplink channel or an uplink signal to which the target power control configuration information is applied.

In some embodiments, the uplink channel is, for example, a CG PUSCH, a PUCCH of SR, a PUCCH of HARQ, a PUCCH of CSI, and a PRACH.

In some embodiments, each uplink channel has a priority, such as a low priority or a high priority.

In some embodiments, the uplink signal is, for example, an SRS and SP-CSI on PUSCH.
(3) A resource set corresponding to the target power control configuration information.
(4) A frequency domain interval between a UL frequency domain resource unit to which the target power control configuration information is applicable and at least one frequency domain resource unit in a transmission format of DL.
(5) A frequency domain interval between a UL frequency domain resource unit to which the target power control configuration information is applicable and at least one frequency domain resource unit in a transmission format of flexible.
(6) A frequency domain interval between a center frequency of the UL frequency domain resource unit to which the target power control configuration information is applicable and a center frequency of a frequency domain resource unit in a transmission format of DL or flexible.

In some embodiments, the indication information is carried in at least one of the following.
(1) RRC information.
(2) Group-common downlink control information (group-common DCI).

In some embodiments, the group-common DCI may include a first indicator field and a second indicator field.

For example, in one piece of group-common DCI, the first indicator field includes resource set 1 and power control configuration 1; and the second indicator field includes resource set 2 and power control configuration 2.

In one piece of group-common DCI, the first indicator field includes resource set 1, power control configuration 1, and uplink transmission type 1; and the second indicator field includes resource set 2, power control configuration 2, and uplink transmission type 2.

In one piece of group-common DCI, the first indicator field includes resource set 1, power control configuration 1, and SRS request 1; and the second indicator field includes resource set 2, power control configuration 2, and SRS request 2.

In one piece of group-common DCI, a first indicator field of a terminal UE 1 includes configuration set 1 and configuration set 2, where configuration set 1 includes resource set 1 and power control configuration 1, and configuration set 2 includes resource set 2 and power control configuration 2; and a first indicator field of a terminal UE 2 includes configuration set 3 and configuration set 4, where configuration set 3 includes resource set 3 and power control configuration 1, and configuration set 4 includes resource set 4 and power control configuration 2.
(3) A Medium Access Control (MAC) Control Element (CE).
(4) Uplink/Downlink transmission scheduled by Downlink Control Information (DCI).

In this embodiment of this application, the terminal receives different power control configuration information configured by the network side device for the first uplink resource and the second uplink resource, so that the transmit power suitable for performing uplink transmission on the target uplink resource may be determined based on the indication information and the different power control configuration information, thereby effectively improving uplink transmission performance between the network side device and the terminal.

The transmit power determining method provided in this embodiment of this application is applied to a network side device 12.

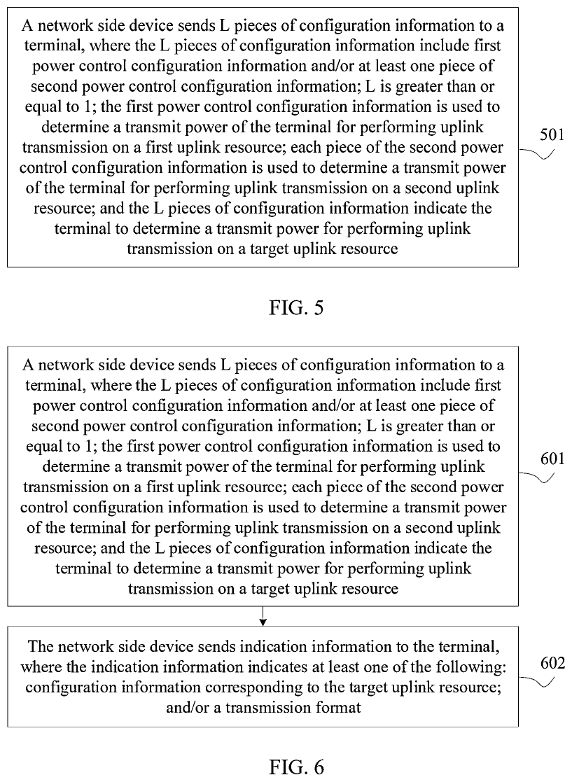

FIG. 5 is a third schematic flowchart of a transmit power determining method according to an embodiment of this application. As shown in FIG. 5, the method includes step 501.

Step 501: A network side device sends L pieces of configuration information to a terminal, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the L pieces of configuration information indicate the terminal to determine a transmit power for performing uplink transmission on a target uplink resource.

In this embodiment of this application, the network side device sends different power control configuration information configured for the first uplink resource and the second uplink resource to the terminal, so that the terminal determines the transmit power suitable for performing uplink transmission on the target uplink resource based on the different power control configuration information, thereby effectively improving uplink transmission performance between the network side device and the terminal.

In some embodiments, the network side device sends RRC signaling to the terminal, where the RRC signaling includes the L pieces of configuration information.

In some embodiments, a frequency domain resource unit of the first uplink resource satisfies at least one of the following:
(1) the frequency domain resource unit of the first uplink resource does not overlap with any frequency domain resource unit in a transmission format of DL or flexible;
(2) a frequency domain interval between the frequency domain resource unit of the first uplink resource and any frequency domain resource unit in a transmission format of DL or flexible is greater than or equal to N frequency domain resource units; and
(3) a frequency domain interval between a center frequency of the first uplink resource and a center frequency of a frequency domain resource unit in a transmission format of DL or flexible is greater than or equal to N1 frequency domain resource units, where
a quantity or a granularity of the frequency domain resource unit of the first uplink resource is the same as or different from a quantity or a granularity of a frequency domain resource unit in a transmission format of DL or flexible.

In some embodiments, a frequency domain resource unit of the second uplink resource satisfies at least one of the following:
(1) the frequency domain resource unit of the second uplink resource overlaps with a frequency domain resource unit in a transmission format of DL or flexible;
(2) the frequency domain resource unit of the second uplink resource does not overlap with a frequency domain resource unit in a transmission format of DL or flexible, and a frequency domain interval between the frequency domain resource unit of the second uplink resource and a frequency domain resource unit in a transmission format of DL or flexible is less than or equal to M frequency domain resource units; and
(3) the frequency domain resource unit of the second uplink resource does not overlap with a frequency domain resource unit in a transmission format of DL or flexible, and a frequency domain interval between a center frequency of the second uplink resource and a center frequency of a frequency domain resource unit in a transmission format of DL or flexible is less than or equal to M1 frequency domain resource units, where
a quantity or a granularity of the frequency domain resource unit of the second uplink resource is the same as or different from a quantity or a granularity of a frequency domain resource unit in a transmission format of DL or flexible.

In some embodiments, the second power control configuration information is related to at least one of the following:
(1) a frequency domain interval between the frequency domain resource unit of the second uplink resource and a frequency domain resource unit in a transmission format of DL or flexible; and
(2) a quantity of frequency domain resource units in a transmission format of DL or flexible and with a frequency domain interval from the frequency domain resource unit of the second uplink resource less than or equal to M frequency domain resource units.

In some embodiments, each configuration information includes at least one of the following power control parameters:
(1) target transmit power;
(2) Alpha;
(3) Pathloss parameter;
(4) Power control loop;
(5) TPC command; and
(6) power control offset.

In some embodiments, the uplink transmission includes at least one of the following.
(1) Periodic uplink transmission or semi-persistent uplink transmission.
(2) Dynamically scheduled uplink transmission.

In this embodiment of this application, the network side device sends different power control configuration information configured for the first uplink resource and the second uplink resource to the terminal, where the first uplink resource has no co-channel interference and/or adjacent channel interference, and the second uplink resource has co-channel interference and/or adjacent channel interference. Therefore, on the basis of considering the co-channel interference and/or the adjacent channel interference, the terminal determines transmit power suitable for performing uplink transmission on the target uplink resource based on the different power control configuration information, thereby effectively improving uplink transmission performance between the network side device and the terminal.

In some embodiments, FIG. 6 is a fourth schematic flowchart of a transmit power determining method according to an embodiment of this application. As shown in FIG. 6, step 601 is basically the same as step 401, but the difference is step 602 is further included.

Step 601: A network side device sends L pieces of configuration information to a terminal, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the L pieces of configuration information indicate the terminal to determine a transmit power for performing uplink transmission on a target uplink resource.

Step 602: The network side device sends indication information to the terminal, where the indication information indicates at least one of the following: configuration information corresponding to the target uplink resource; and/or a transmission format.

In some embodiments, the indication information includes at least one of the following:
(1) at least one resource set; and
(2) at least one power adjustment indication.

Each resource set includes at least one of the following:
(1) a time domain and/or frequency domain resource;
(2) a transmission format;
(3) target power control configuration information corresponding to the resource set;
(4) an uplink channel or an uplink signal corresponding to the resource set;
(5) a frequency domain interval from at least one frequency domain resource unit in a transmission format of DL;
(6) a frequency domain interval from at least one frequency domain resource unit in a transmission format of flexible; and
(7) a frequency domain interval between a center frequency of the resource set and a center frequency of a frequency domain resource unit in a transmission format of DL or flexible.

Each power adjustment indication includes at least one of the following:
(1) target power control configuration information;
(2) an uplink channel or an uplink signal to which the target power control configuration information is applied;
(3) a resource set corresponding to the target power control configuration information;
(4) a frequency domain interval between a UL frequency domain resource unit to which the target power control configuration information is applicable and at least one frequency domain resource unit in a transmission format of DL;
(5) a frequency domain interval between a UL frequency domain resource unit to which the target power control configuration information is applicable and at least one frequency domain resource unit in a transmission format of flexible; and
(6) a frequency domain interval between a center frequency of the UL frequency domain resource unit to which the target power control configuration information is applicable and a center frequency of a frequency domain resource unit in a transmission format of DL or flexible.

In some embodiments, the indication information is carried in at least one of the following:
(1) RRC information;
(2) group-common DCI;
(3) MAC CE; and
(4) uplink/downlink transmission scheduled by using DCI.

In this embodiment of this application, the network side device sends different power control configuration information configured for the first uplink resource and the second uplink resource to the terminal, and sends the indication information to the terminal, so that the terminal determines the transmit power suitable for performing uplink transmission on the target uplink resource based on the indication information and the different power control configuration information, thereby effectively improving uplink transmission performance between the network side device and the terminal.

The transmit power determining method provided in this embodiment of this application may be executed by a transmit power determining apparatus. In this embodiment of this application, that the transmit power determining apparatus performs the transmit power determining method is used as an example to describe the transmit power determining apparatus provided in the embodiments of this application.

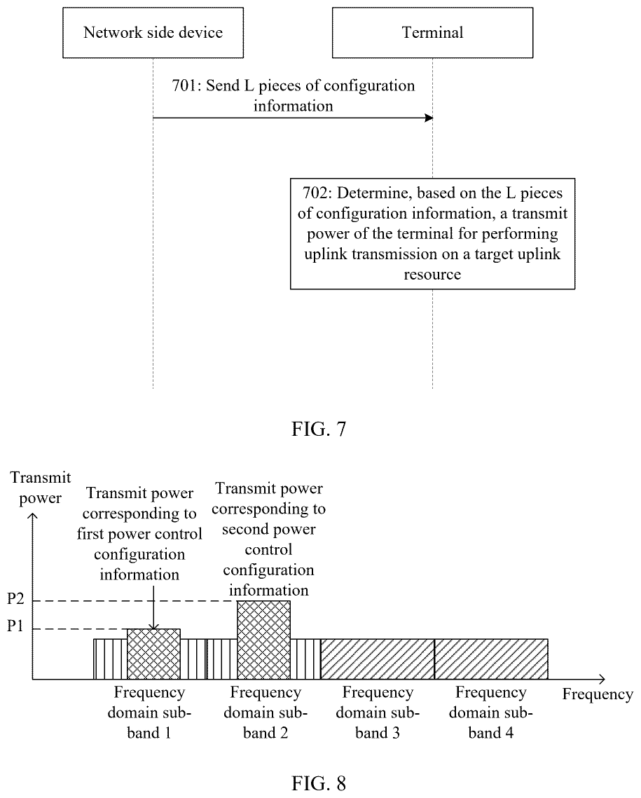

FIG. 7 is a schematic diagram of signaling interaction of a transmit power determining method according to an embodiment of this application.

Step 701: A network side device sends L pieces of configuration information to a terminal, and the terminal receives the L pieces of configuration information sent by the network side device.

Specifically, the L pieces of configuration information include first power control configuration information and/or at least one piece of second power control configuration information.

Step 702: The terminal determines, based on the L pieces of configuration information, a transmit power of the terminal for performing uplink transmission on a target uplink resource.

In some embodiments, the terminal may determine indication information based on a manner predefined or preconfigured by a protocol; or the terminal may receive the indication information sent by the network side device. Then the terminal may determine, based on the indication information and the configuration information, the transmit power of the terminal for performing uplink transmission on the target uplink resource.

In some embodiments, the terminal may determine, based on the indication information, whether the target uplink resource belongs to a first uplink resource or a second uplink resource, and then determine, based on an uplink resource to which the target uplink resource belongs, a transmit power for uplink transmission corresponding to the uplink resource to which the target uplink resource belongs as the transmit power of the terminal for performing uplink transmission on the target uplink resource.

The following uses an example in which the network side device is configured with 2 pieces of configuration information, and the 2 pieces of configuration information respectively include first power control configuration information and second power control configuration information, to describe the transmit power determining method.

FIG. 8 is a first schematic diagram of a relationship between frequency domain locations of different frequency domain resource units and a transmit power for uplink transmission according to an embodiment of this application.

Refer to FIG. 8, the terminal receives indication information, where the indication information indicates that frequency domain sub-band 1 in a transmission format of UL corresponds to first power control configuration information (Type-1 power control), and frequency domain sub-band 2 in a transmission format of UL corresponds to second power control configuration information (Type-2 power control).

When the terminal needs to send uplink data on a PUSCH of frequency domain sub-band 1, the terminal determines, based on the first power control configuration information, that the transmit power for uplink transmission is P1.

Specifically, when the terminal needs to send uplink data on a PUSCH of frequency domain sub-band 1, because a frequency domain interval between frequency domain sub-band 1 and nearest frequency domain sub-band 3 in a transmission format of DL is 1 frequency domain sub-band, it can be considered that effect of adjacent channel interference is small, and the terminal may determine the transmit power for uplink transmission based on the first power control configuration information without considering the adjacent channel interference.

When the terminal needs to send uplink data on a PUSCH of frequency domain sub-band 2, the terminal determines, based on the second power control configuration information, that the transmit power for uplink transmission is P2.

Specifically, when the terminal needs to send uplink data on a PUSCH of frequency domain sub-band 2, because frequency domain sub-band 2 is adjacent to nearest frequency domain sub-band 3 in a transmission format of DL, it can be considered that effect of adjacent channel interference is great, and the terminal may determine the transmit power for uplink transmission based on the second power control configuration information. In this case, the adjacent channel interference needs to be considered.

In some embodiments, it is set that P2>P1 to improve performance of uplink transmission by increasing a transmit power of an uplink channel.

When the terminal needs to send uplink data on both a PUSCH of frequency domain sub-band 1 and a PUSCH of frequency domain sub-band 2, the terminal may perform any one of the following operations:
(1) determining, based on the first power control configuration information, that a transmit power for common uplink transmission on frequency domain sub-band 1 and frequency domain sub-band 2 is P1;
(2) determining, based on the second power control configuration information, that a transmit power for common uplink transmission on frequency domain sub-band 1 and frequency domain sub-band 2 is P2; and
(3) determining, based on the first power control configuration information, that the transmit power for uplink transmission is P1, determining, based on the second power control configuration information, that the transmit power for uplink transmission is P2, and then calculating an average value of P1 and P2 as the transmit power for common uplink transmission on frequency domain sub-band 1 and frequency domain sub-band 2, that is, (P1+P2)/2.

In some embodiments, refer to FIG. 8, in the configured 2 pieces of configuration information, the network side device configures the first power control configuration information to be corresponding to a frequency domain sub-band in a transmission format of UL and with a frequency domain interval from a frequency domain sub-band in a transmission format of DL greater than or equal to N2 frequency domain sub-bands, and configures the second power control configuration information to be corresponding to a frequency domain sub-band in a transmission format of UL and with a frequency domain interval from a frequency domain sub-band in a transmission format of DL less than N2 frequency domain sub-bands. In this embodiment, N2=1 is used as an example.

The terminal receives indication information, where the indication information indicates that a transmission format of frequency domain sub-band 1 is UL, a transmission format of frequency domain sub-band 2 is UL, a transmission format of frequency domain sub-band 3 is DL, and a transmission format of frequency domain sub-band 4 is DL.

When the terminal needs to send uplink data on a PUSCH of frequency domain sub-band 1, because a frequency domain interval between frequency domain sub-band 1 and a nearest frequency domain sub-band in a transmission format of DL, that is, frequency domain sub-band 3, is 1 frequency domain sub-band, the terminal determines, based on the first power control configuration information, that the transmit power for uplink transmission is P1.

Specifically, when the terminal needs to send uplink data on a PUSCH of frequency domain sub-band 1, because a frequency domain interval between frequency domain sub-band 1 and nearest frequency domain sub-band 3 in a transmission format of DL is 1 frequency domain sub-band, it can be considered that effect of adjacent channel interference is small, and the terminal may determine the transmit power for uplink transmission based on the first power control configuration information without considering the adjacent channel interference.

When the terminal needs to send uplink data on a PUSCH of frequency domain sub-band 2, because a frequency domain interval between frequency domain sub-band 2 and a nearest frequency domain sub-band in a transmission format of DL, that is, frequency domain sub-band 3, is 0 frequency domain sub-band, the terminal determines, based on the second power control configuration information, that the transmit power for uplink transmission is P2.

Specifically, when the terminal needs to send uplink data on a PUSCH of frequency domain sub-band 2, because frequency domain sub-band 2 is adjacent to nearest frequency domain sub-band 3 in a transmission format of DL, it can be considered that effect of adjacent channel interference is great, and the terminal may determine the transmit power for uplink transmission based on the second power control configuration information. In this case, the adjacent channel interference needs to be considered.

In some embodiments, it is set that P2>P1 to improve performance of uplink transmission by increasing a transmit power of an uplink channel.

The following uses an example in which the network side device is configured with 3 pieces of configuration information, and the 3 pieces of configuration information respectively include first power control configuration information and 2 pieces of second power control configuration information including different parameters, to describe the transmit power determining method.

FIG. 9 is a second schematic diagram of a relationship between frequency domain locations of different frequency domain resource units and a transmit power for uplink transmission according to an embodiment of this application.

Refer to FIG. 9, the terminal receives indication information, where the indication information indicates that frequency domain sub-band 1 in a transmission format of UL corresponds to first power control configuration information (Type-1 power control), frequency domain sub-band 2 in a transmission format of UL corresponds to second power control configuration information A (Type-2A power control), and frequency domain sub-band 5 in a transmission format of UL corresponds to second power control configuration information B (Type-2B power control).

When the terminal needs to send uplink data on a PUSCH of frequency domain sub-band 1, the terminal determines, based on the first power control configuration information, that the transmit power for uplink transmission is P1.

Specifically, when the terminal needs to send uplink data on a PUSCH of frequency domain sub-band 1, because a frequency domain interval between frequency domain sub-band 1 and nearest frequency domain sub-band 3 in a transmission format of DL is 1 frequency domain sub-band, it can be considered that effect of adjacent channel interference is small, and the terminal may determine the transmit power for uplink transmission based on the first power control configuration information without considering the adjacent channel interference.

When the terminal needs to send uplink data on a PUSCH of frequency domain sub-band 2, the terminal determines, based on the second power control configuration information A, that the transmit power for uplink transmission is P2.

Specifically, when the terminal needs to send uplink data on a PUSCH of frequency domain sub-band 2, because frequency domain sub-band 2 is unilaterally adjacent to nearest frequency domain sub-band 3 in a transmission format of DL, it can be considered that effect of adjacent channel interference is great, and the terminal may determine the transmit power for uplink transmission based on the second power control configuration information A. In this case, the adjacent channel interference needs to be considered.

When the terminal needs to send uplink data on a PUSCH of frequency domain sub-band 5, the terminal determines, based on the second power control configuration information B, that the transmit power for uplink transmission is P3.

Specifically, when the terminal needs to send uplink data on a PUSCH of frequency domain sub-band 5, because frequency domain sub-band 5 is adjacent to both nearest frequency domain sub-band 4 in a transmission format of DL and frequency domain sub-band 6, it can be considered that effect of adjacent channel interference is greater, and the terminal may determine the transmit power for uplink transmission based on the second power control configuration information B. In this case, the adjacent channel interference needs to be considered.

In some embodiments, it is set that P3>P2>P1 to improve performance of uplink transmission by increasing a transmit power of an uplink channel.

It should be noted that the transmit power determining method provided in this embodiment of this application may be used in authorized frequency bands and unauthorized frequency bands, and may also be used in single-carrier scenarios or multi-carrier scenarios, so this is not limited herein.

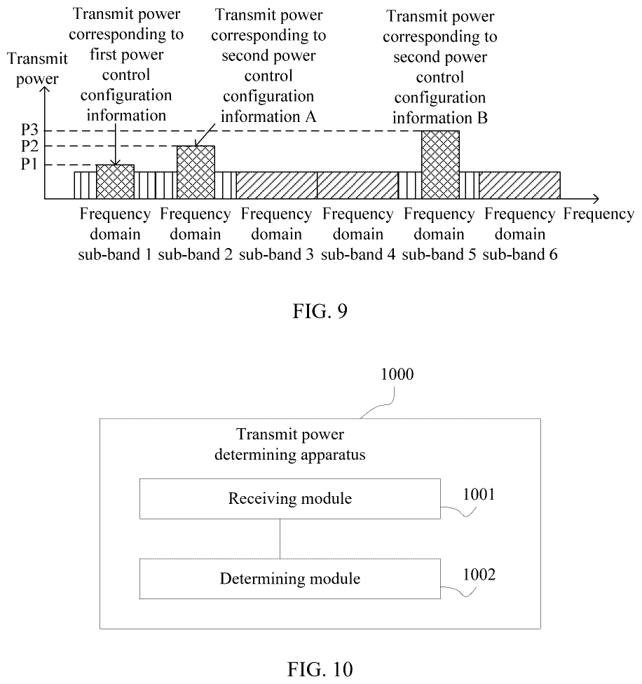

FIG. 10 is a first schematic diagram of a structure of a transmit power determining apparatus according to an embodiment of this application. As shown in FIG. 10, the transmit power determining apparatus 1000 is applied to a terminal and includes:
a receiving module 1001, configured to receive L pieces of configuration information sent by a network side device, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; and each piece of the second power control configuration information is used to determine a transmit power of the terminal for performing uplink transmission on a second uplink resource; and
a determining module 1002, configured to determine, based on the L pieces of configuration information, a transmit power for performing uplink transmission on a target uplink resource.

In the transmit power determining apparatus provided in this embodiment of this application, the transmit power determining apparatus receives different power control configuration information configured by the network side device for the first uplink resource and the second uplink resource, so that the transmit power suitable for performing uplink transmission on the target uplink resource may be determined based on the different power control configuration information, thereby effectively improving uplink transmission performance between the network side device and the terminal.

In some embodiments, the determining module 1002 is configured to determine the transmit power for uplink transmission based on indication information and the L pieces of configuration information, where the indication information indicates at least one of the following: configuration information corresponding to the target uplink resource; and a transmission format.

In some embodiments, a frequency domain resource unit of the first uplink resource satisfies at least one of the following:
(1) the frequency domain resource unit of the first uplink resource does not overlap with any frequency domain resource unit in a transmission format of DL or flexible;
(2) a frequency domain interval between the frequency domain resource unit of the first uplink resource and any frequency domain resource unit in a transmission format of DL or flexible is greater than or equal to N frequency domain resource units; and
(3) a frequency domain interval between a center frequency of the first uplink resource and a center frequency of a frequency domain resource unit in a transmission format of DL or flexible is greater than or equal to N1 frequency domain resource units, where
a quantity or a granularity of the frequency domain resource unit of the first uplink resource is the same as or different from a quantity or a granularity of a frequency domain resource unit in a transmission format of DL or flexible.

In some embodiments, a frequency domain resource unit of the second uplink resource satisfies at least one of the following:
(1) the frequency domain resource unit of the second uplink resource overlaps with a frequency domain resource unit in a transmission format of DL or flexible;
(2) the frequency domain resource unit of the second uplink resource does not overlap with a frequency domain resource unit in a transmission format of DL or flexible, and a frequency domain interval between the frequency domain resource unit of the second uplink resource and a frequency domain resource unit in a transmission format of DL or flexible is less than or equal to M frequency domain resource units; and
(3) the frequency domain resource unit of the second uplink resource does not overlap with a frequency domain resource unit in a transmission format of DL or flexible, and a frequency domain interval between a center frequency of the second uplink resource and a center frequency of a frequency domain resource unit in a transmission format of DL or flexible is less than or equal to M1 frequency domain resource units, where
a quantity or a granularity of the frequency domain resource unit of the second uplink resource is the same as or different from a quantity or a granularity of a frequency domain resource unit in a transmission format of DL or flexible.

In some embodiments, the second power control configuration information is related to at least one of the following:
(1) a frequency domain interval between the frequency domain resource unit of the second uplink resource and a frequency domain resource unit in a transmission format of DL or flexible; and
(2) a quantity of frequency domain resource units in a transmission format of DL or flexible and with a frequency domain interval from the frequency domain resource unit of the second uplink resource less than or equal to M frequency domain resource units.

In some embodiments, the receiving module 1001 is further configured to receive the indication information sent by the network side device; and/or the determining module 1002 is further configured to determine the indication information based on a manner predefined or preconfigured by a protocol.

In some embodiments, the indication information includes at least one of the following:
(1) at least one resource set; and
(2) at least one power adjustment indication.

Each resource set includes at least one of the following:
(1) a time domain and/or frequency domain resource;
(2) a transmission format;
(3) target power control configuration information corresponding to the resource set;
(4) an uplink channel or an uplink signal corresponding to the resource set;
(5) a frequency domain interval from at least one frequency domain resource unit in a transmission format of DL;
(6) a frequency domain interval from at least one frequency domain resource unit in a transmission format of flexible; and
(7) a frequency domain interval between a center frequency of the resource set and a center frequency of a frequency domain resource unit in a transmission format of DL or flexible.

Each power adjustment indication includes at least one of the following:
(1) target power control configuration information;
(2) an uplink channel or an uplink signal to which the target power control configuration information is applied;
(3) a resource set corresponding to the target power control configuration information;
(4) a frequency domain interval between a UL frequency domain resource unit to which the target power control configuration information is applicable and at least one frequency domain resource unit in a transmission format of DL;
(5) a frequency domain interval between a UL frequency domain resource unit to which the target power control configuration information is applicable and at least one frequency domain resource unit in a transmission format of flexible; and
(6) a frequency domain interval between a center frequency of the UL frequency domain resource unit to which the target power control configuration information is applicable and a center frequency of a frequency domain resource unit in a transmission format of DL or flexible.

In some embodiments, the indication information is carried in at least one of the following:
(1) RRC information;
(2) group-common DCI;
(3) MAC CE; and
(4) uplink/downlink transmission scheduled by using DCI.

In some embodiments, the configuration information includes at least one of the following power control parameters:
(1) target transmit power;
(2) Alpha;
(3) Pathloss parameter;
(4) Power control loop;
(5) TPC command; and
(6) Power control offset.

In some embodiments, the uplink transmission includes at least one of the following.
(1) Periodic uplink transmission or semi-persistent uplink transmission.
(2) Dynamically scheduled uplink transmission.

In some embodiments, in a case that the uplink transmission is repeated transmission, the terminal performs any one of the following operations:
(1) separately determining, by the terminal, a transmit power of each repetition based on the L pieces of configuration information and a resource in which each repetition is located; and
(2) determining, by the terminal, transmit powers of all repetitions based on the L pieces of configuration information and a resource in which a Y^{th} repetition is located, where Y is greater than or equal to 1.

In some embodiments, the transmit power determining apparatus receives RRC signaling sent by the network side device, where the RRC signaling includes the L pieces of configuration information.

In this embodiment of this application, the receiving module receives different power control configuration information configured by the network side device for the first uplink resource and the second uplink resource, and then the determining module determines the transmit power suitable for performing uplink transmission on the target uplink resource based on the indication information and the different power control configuration information, thereby effectively improving uplink transmission performance between the network side device and the terminal.

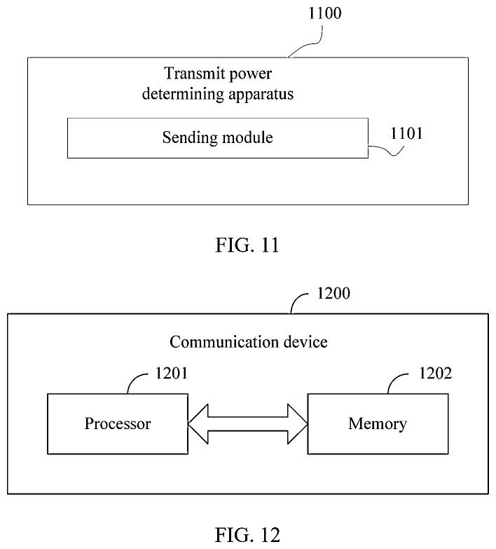

FIG. 11 is a second schematic diagram of a structure of a transmit power determining apparatus according to an embodiment of this application. As shown in FIG. 11, the transmit power determining apparatus 1100 is applied to a network side device and includes:
a sending module 1101, configured to send L pieces of configuration information to a terminal, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the L pieces of configuration information indicate the terminal to determine a transmit power for performing uplink transmission on a target uplink resource.

In this embodiment of this application, the sending module sends different power control configuration information configured for the first uplink resource and the second uplink resource to the terminal, so that the terminal determines the transmit power suitable for performing uplink transmission on the target uplink resource based on the different power control configuration information, thereby effectively improving uplink transmission performance between the network side device and the terminal.

In some embodiments, a frequency domain resource unit of the first uplink resource satisfies at least one of the following:
(1) the frequency domain resource unit of the first uplink resource does not overlap with any frequency domain resource unit in a transmission format of DL or flexible;
(2) a frequency domain interval between the frequency domain resource unit of the first uplink resource and any frequency domain resource unit in a transmission format of DL or flexible is greater than or equal to N frequency domain resource units; and
(3) a frequency domain interval between a center frequency of the first uplink resource and a center frequency of a frequency domain resource unit in a transmission format of DL or flexible is greater than or equal to N1 frequency domain resource units, where a quantity or a granularity of the frequency domain resource unit of the first uplink resource is the same as or different from a quantity or a granularity of a frequency domain resource unit in a transmission format of DL or flexible.

In some embodiments, a frequency domain resource unit of the second uplink resource satisfies at least one of the following:
(1) the frequency domain resource unit of the second uplink resource overlaps with a frequency domain resource unit in a transmission format of DL or flexible;
(2) the frequency domain resource unit of the second uplink resource does not overlap with a frequency domain resource unit in a transmission format of DL or flexible, and a frequency domain interval between the frequency domain resource unit of the second uplink resource and a frequency domain resource unit in a transmission format of DL or flexible is less than or equal to M frequency domain resource units; and
(3) the frequency domain resource unit of the second uplink resource does not overlap with a frequency domain resource unit in a transmission format of DL or flexible, and a frequency domain interval between a center frequency of the second uplink resource and a center frequency of a frequency domain resource unit in a transmission format of DL or flexible is less than or equal to M1 frequency domain resource units, where
a quantity or a granularity of the frequency domain resource unit of the second uplink resource is the same as or different from a quantity or a granularity of a frequency domain resource unit in a transmission format of DL or flexible.

In some embodiments, the second power control configuration information is related to at least one of the following:
(1) a frequency domain interval between the frequency domain resource unit of the second uplink resource and a frequency domain resource unit in a transmission format of DL or flexible; and
(2) a quantity of frequency domain resource units in a transmission format of DL or flexible and with a frequency domain interval from the frequency domain resource unit of the second uplink resource less than or equal to M frequency domain resource units.

In some embodiments, the sending module 1101 is further configured to send indication information to the terminal, where the indication information indicates at least one of the following: configuration information corresponding to the target uplink resource; and a transmission format.

In some embodiments, the indication information includes at least one of the following:
(1) at least one resource set; and
(2) at least one power adjustment indication.

Each resource set includes at least one of the following:
(1) a time domain and/or frequency domain resource;
(2) a transmission format;
(3) target power control configuration information corresponding to the resource set;
(4) an uplink channel or an uplink signal corresponding to the resource set;
(5) a frequency domain interval from at least one frequency domain resource unit in a transmission format of DL;
(6) a frequency domain interval from at least one frequency domain resource unit in a transmission format of flexible; and
(7) a frequency domain interval between a center frequency of the resource set and a center frequency of a frequency domain resource unit in a transmission format of DL or flexible.

Each power adjustment indication includes at least one of the following:
(1) target power control configuration information;
(2) an uplink channel or an uplink signal to which the target power control configuration information is applied;
(3) a resource set corresponding to the target power control configuration information;
(4) a frequency domain interval between a UL frequency domain resource unit to which the target power control configuration information is applicable and at least one frequency domain resource unit in a transmission format of DL;
(5) a frequency domain interval between a UL frequency domain resource unit to which the target power control configuration information is applicable and at least one frequency domain resource unit in a transmission format of flexible; and
(6) a frequency domain interval between a center frequency of the UL frequency domain resource unit to which the target power control configuration information is applicable and a center frequency of a frequency domain resource unit in a transmission format of DL or flexible.

In some embodiments, the indication information is carried in at least one of the following:
(1) RRC information;
(2) group-common DCI;
(3) MAC CE; and
(4) uplink/downlink transmission scheduled by using DCI.

In some embodiments, the configuration information includes at least one of the following power control parameters:
(1) target transmit power;
(2) Alpha;
(3) Pathloss parameter;
(4) Power control loop;
(5) TPC command; and
(6) Power control offset.

In some embodiments, the uplink transmission includes at least one of the following.
(1) Periodic uplink transmission or semi-persistent uplink transmission.
(2) Dynamically scheduled uplink transmission.

In some embodiments, the sending module 1101 is configured to send RRC signaling to the terminal, where the RRC signaling includes the L pieces of configuration information.

In this embodiment of this application, the sending module sends different power control configuration information configured for the first uplink resource and the second uplink resource to the terminal, and sends the indication information to the terminal, so that the terminal determines the transmit power suitable for performing uplink transmission on the target uplink resource based on the indication information and the different power control configuration information, thereby effectively improving uplink transmission performance between the network side device and the terminal.

The transmit power determining apparatus in this embodiment of this application may be an electronic device, for example, an electronic device with an operating system, or may be a component in the electronic device, for example, an integrated circuit or a chip. The electronic device may be a terminal, or another device other than the terminal. For example, the electronic device may be a mobile phone, a tablet computer, a notebook computer, a palmtop computer, an in-vehicle electronic device, a MID, an AR/VR device, a robot, a wearable device, an UMPC, a netbook, a PDA, or the like; and may further be a server, a Network Attached Storage (NAS), a PC, a television (TV), a teller machine, a self-service machine, or the like. This is not specifically limited in this embodiment of this application. For example, the terminal may include but is not limited to the foregoing listed types of the terminal 11. The another device may be a server, an NAS, and the like. This is not specifically limited in this embodiment of this application.

The transmit power determining apparatus in this embodiment of this application may be an apparatus with an operating system. The operating system may be an Android operating system, an iOS operating system, or another possible operating system. This is not specifically limited in this embodiment of this application.

The transmit power determining apparatus provided in this embodiment of this application can implement the processes implemented in the method embodiments in FIG. 2 to FIG. 9, and a same technical effect is achieved. To avoid repetition, details are not described herein again.

FIG. 12 is a schematic diagram of a structure of a communication device according to an embodiment of this application. As shown in FIG. 12, the communication device 1200 includes a processor 1201 and a memory 1202. The memory 1202 stores a program or an instruction that can be run on the processor 1201. For example, when the communication device 1200 is a terminal, the program or the instruction is executed by the processor 1201 to implement the steps of the transmit power determining method embodiment, and a same technical effect can be achieved. In a case that the communication device 1200 is a network side device, when the program or the instruction is executed by the processor 1201, the steps of the transmit power determining method embodiment corresponding to the network side device are implemented, and a same technical effect can be achieved. To avoid repetition, details are not described herein again.

An embodiment of this application further provides a terminal, including a processor and a communication interface. The communication interface is configured to receive L pieces of configuration information sent by a network side device, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the processor is configured to determine, based on the L pieces of configuration information, a transmit power for performing uplink transmission on a target uplink resource. The terminal embodiment is corresponding to the terminal side method embodiment, each implementation process and implementation of the method embodiment can be applied to the terminal embodiment, and a same technical effect can be achieved.

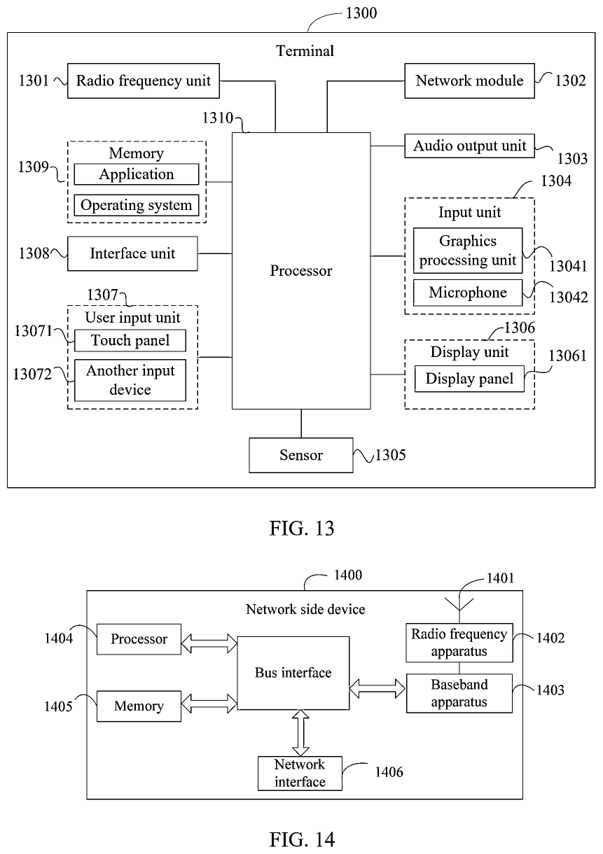

FIG. 13 is a schematic diagram of a structure of a terminal according to an embodiment of this application. As shown in FIG. 13, the terminal 1300 includes but is not limited to at least some components in: a radio frequency unit 1301, a network module 1302, an audio output unit 1303, an input unit 1304, a sensor 1305, a display unit 1306, a user input unit 1307, an interface unit 1308, a memory 1309, and a processor 1310.

A person skilled in the art can understand that the terminal 1300 may further include a power supply (such as a battery) that supplies power to each component. The power supply may be logically connected to the processor 1310 by using a power supply management system, to implement functions such as charging and discharging management, and power consumption management by using the power supply management system. The terminal structure shown in FIG. 13 constitutes no limitation on the terminal, and the terminal may include more or fewer components than those shown in the figure, or combine some components, or have different component arrangements. Details are not described herein.

It should be understood that in this embodiment of this application, the input unit 1304 may include a Graphics Processing Unit (GPU) 13041 and a microphone 13042. The graphics processing unit 13041 processes image data of a static picture or a video obtained by an image capture apparatus (for example, a camera) in a video capture mode or an image capture mode. The display unit 1306 may include a display panel 13061, and the display panel 13061 may be configured in a form of a liquid crystal display, an organic light-emitting diode, or the like. The user input unit 1307 includes at least one of a touch panel 13071 and another input device 13072. The touch panel 13071 is also referred to as a touchscreen. The touch panel 13071 may include two parts: a touch detection apparatus and a touch controller. The another input device 13072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1301 may transmit the downlink data to the processor 1310 for processing. In addition, the radio frequency unit 1301 may send uplink data to the network side device. Generally, the radio frequency unit 1301 includes but is not limited to an antenna, an amplifier, a transceiver, a coupler, a low noise amplifier, a duplexer, and the like.

The memory 1309 may be configured to store a software program or an instruction and various data. The memory 1309 may mainly include a first storage area for storing a program or an instruction and a second storage area for storing data. The first storage area may store an operating system, and an application or an instruction required by at least one function (for example, a sound playing function or an image playing function). In addition, the memory 1309 may be a volatile memory or a non-volatile memory, or the memory 1309 may include a volatile memory and a non-volatile memory. The nonvolatile memory may be a (Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1309 in this embodiment of this application includes but is not limited to these memories and any memory of another proper type.

The processor 1310 may include one or more processing units. In some embodiments, an application processor and a modem processor are integrated into the processor 1310. The application processor mainly processes an operating system, a user interface, an application, or the like. The modem processor mainly processes a wireless communication signal, for example, a baseband processor. It may be understood that, in some embodiments, the modem processor may not be integrated into the processor 1310.

The radio frequency unit 1301 is configured to receive L pieces of configuration information sent by a network side device, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; and each piece of the second power control configuration information is used to determine a transmit power of the terminal for performing uplink transmission on a second uplink resource.

The processor 1310 is configured to determine, based on the L pieces of configuration information, a transmit power for performing uplink transmission on a target uplink resource.

In this embodiment of this application, the terminal receives L pieces of configuration information sent by the network side device, where the configuration information includes first power control configuration information used to determine a transmit power of the terminal for performing uplink transmission on a first uplink resource and/or at least one piece of second power control configuration information used to determine a transmit power of the terminal for performing uplink transmission on a second uplink resource. Then the terminal may determine, based on the configuration information, the transmit power for uplink transmission on the target uplink resource. The terminal receives different power control configuration information configured by the network side device for the first uplink resource and the second uplink resource, so that the transmit power suitable for performing uplink transmission on the target uplink resource may be determined based on the different power control configuration information, thereby effectively improving uplink transmission performance between the network side device and the terminal.

In some embodiments, the processor 1310 is further configured to determine the transmit power for uplink transmission based on indication information and the L pieces of configuration information, where the indication information indicates at least one of the following: configuration information corresponding to the target uplink resource; and a transmission format.

In this embodiment of this application, the terminal receives different power control configuration information configured by the network side device for the first uplink resource and the second uplink resource, so that the transmit power suitable for performing uplink transmission on the target uplink resource may be determined based on the indication information and the different power control configuration information, thereby effectively improving uplink transmission performance between the network side device and the terminal.

An embodiment of this application further provides a network side device, including a processor and a communication interface. The communication interface is configured to send L pieces of configuration information to a terminal, where the L pieces of configuration information include first power control configuration information and/or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the L pieces of configuration information indicate the terminal to determine a transmit power for performing uplink transmission on a target uplink resource. This network side device embodiment is corresponding to the foregoing method embodiment of the network side device. Each implementation process and implementation of the foregoing method embodiment may be applicable to this network side device embodiment, and a same technical effect can be achieved.

FIG. 14 is a schematic diagram of a structure of a network side device according to an embodiment of this application. As shown in FIG. 14, the network side device 1400 includes an antenna 1401, a radio frequency apparatus 1402, a baseband apparatus 1403, a processor 1404, and a memory 1405. The antenna 1401 is connected to the radio frequency apparatus 1402. In an uplink direction, the radio frequency apparatus 1402 receives information by using the antenna 1401, and sends the received information to the baseband apparatus 1403 for processing. In a downlink direction, the baseband apparatus 1403 processes information that needs to be sent, and sends processed information to the radio frequency apparatus 1402. The radio frequency apparatus 1402 processes the received information, and sends processed information by using the antenna 1401.

In the foregoing embodiment, the method performed by the network side device may be implemented in a baseband apparatus 1403. The baseband apparatus 1403 includes a baseband processor.

For example, the baseband apparatus 1403 may include at least one baseband board. A plurality of chips are disposed on the baseband board. As shown in FIG. 14, one chip is, for example, a baseband processor, and is connected to the memory 1405 by using a bus interface, to invoke a program in the memory 1405 to perform the operations of the network device shown in the foregoing method embodiment.

The network side device may further include a network interface 1406, and the interface is, for example, a Common Public Radio Interface (CPRI).

Specifically, the network side device 1400 in this embodiment of this application further includes an instruction or a program that is stored in the memory 1405 and that can run on the processor 1404. The processor 1404 invokes the instruction or the program stored in the memory 1405 to perform the transmit power determining method corresponding to the network side device, and a same technical effect is achieved. To avoid repetition, details are not described herein.

An embodiment of this application further provides a transmit power determining system, including a terminal and a network side device, where the terminal may be configured to perform the steps of the transmit power determining method corresponding to the terminal, and the network side device may be configured to perform the steps of the transmit power determining method corresponding to the network side device.

An embodiment of this application further provides a readable storage medium. The readable storage medium may be volatile or non-volatile. The readable storage medium stores a program or an instruction, the program or the instruction is executed by a processor to implement the processes of the transmit power determining method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application also provides a chip. The chip includes a processor and a communication interface, and the communication interface is coupled to the processor. The processor is configured to run a program or an instruction, to implement the processes of the transmit power determining method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application also provides a computer program/program product, and the computer program/program product is stored in a storage medium. The computer program/program product is executed by at least one processor to implement the processes of the transmit power determining method embodiment, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the related art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A transmit power determining method, comprising:
receiving, by a terminal, L pieces of configuration information sent by a network side device, wherein the L pieces of configuration information comprise first power control configuration information or at least one piece of second power control configuration information; L is greater than or equal to 1; the first power control configuration information is used to determine a transmit power of the terminal for performing uplink transmission on a first uplink resource; and each piece of the second power control configuration information is used to determine a transmit power of the terminal for performing uplink transmission on a second uplink resource; and
determining, by the terminal based on the L pieces of configuration information, a transmit power for performing uplink transmission on a target uplink resource.

2. The transmit power determining method according to claim 1, wherein the determining, by the terminal based on the L pieces of configuration information, the transmit power for performing uplink transmission on the target uplink resource comprises:
determining, by the terminal, the transmit power for uplink transmission based on indication information and the L pieces of configuration information,
wherein the indication information indicates at least one of the following:
configuration information corresponding to the target uplink resource; or
a transmission format.

3. The transmit power determining method according to claim 1, wherein a frequency domain resource unit of the first uplink resource satisfies at least one of the following:
the frequency domain resource unit of the first uplink resource does not overlap with any frequency domain resource unit in a transmission format of downlink (DL) or flexible;
a frequency domain interval between the frequency domain resource unit of the first uplink resource and any frequency domain resource unit in the transmission format of DL or flexible is greater than or equal to N frequency domain resource units; or
a frequency domain interval between a center frequency of the first uplink resource and a center frequency of the frequency domain resource unit in the transmission format of DL or flexible is greater than or equal to N1 frequency domain resource units,
wherein a quantity or a granularity of the frequency domain resource unit of the first uplink resource is the same as or different from a quantity or a granularity of the frequency domain resource unit in the transmission format of DL or flexible.

4. The transmit power determining method according to claim 1, wherein a frequency domain resource unit of the second uplink resource satisfies at least one of the following:
the frequency domain resource unit of the second uplink resource overlaps with a frequency domain resource unit in a transmission format of DL or flexible;
the frequency domain resource unit of the second uplink resource does not overlap with the frequency domain resource unit in the transmission format of DL or flexible, and a frequency domain interval between the frequency domain resource unit of the second uplink resource and the frequency domain resource unit in the transmission format of DL or flexible is less than or equal to M frequency domain resource units; or
the frequency domain resource unit of the second uplink resource does not overlap with the frequency domain resource unit in the transmission format of DL or flexible, and a frequency domain interval between a center frequency of the second uplink resource and a center frequency of the frequency domain resource unit in the transmission format of DL or flexible is less than or equal to M1 frequency domain resource units,
wherein a quantity or a granularity of the frequency domain resource unit of the second uplink resource is the same as or different from a quantity or a granularity of the frequency domain resource unit in the transmission format of DL or flexible.

5. The transmit power determining method according to claim 1 wherein the second power control configuration information is related to at least one of the following:
a frequency domain interval between the frequency domain resource unit of the second uplink resource and a frequency domain resource unit in a transmission format of DL or flexible; or
a quantity of frequency domain resource units in the transmission format of DL or flexible and with a frequency domain interval from the frequency domain resource unit of the second uplink resource less than or equal to M frequency domain resource units.

6. The transmit power determining method according to claim 2, wherein before the determining, by the terminal based on the L pieces of configuration information, the transmit power for performing uplink transmission on the target uplink resource, the method further comprises at least one of the following:
determining, by the terminal, the indication information based on a manner predefined or preconfigured by a protocol; or
receiving, by the terminal, the indication information sent by the network side device.

7. The transmit power determining method according to claim 2, wherein the indication information comprises at least one of the following:
at least one resource set, wherein each resource set comprises at least one of the following: a time domain or frequency domain resource, a transmission format, target power control configuration information corresponding to the resource set, an uplink channel or an uplink signal corresponding to the resource set, a frequency domain interval from at least one frequency domain resource unit in a transmission format of DL, a frequency domain interval from at least one frequency domain resource unit in a transmission format of flexible, or a frequency domain interval between a center frequency of the resource set and a center frequency of the frequency domain resource unit in the transmission format of DL or flexible; or
at least one power adjustment indication, wherein each power adjustment indication comprises at least one of the following: target power control configuration information, an uplink channel or an uplink signal to which the target power control configuration information is applied, a resource set corresponding to the target power control configuration information, a frequency domain interval between an uplink (UL) frequency domain resource unit to which the target power control configuration information is applicable and at least one frequency domain resource unit in the transmission format of DL, a frequency domain interval between a UL frequency domain resource unit to which the target power control configuration information is applicable and at least one frequency domain resource unit in the transmission format of flexible; or a frequency domain interval between a center frequency of the UL frequency domain resource unit to which the target power control configuration information is applicable and a center frequency of the frequency domain resource unit in the transmission format of DL or flexible.

8. The transmit power determining method according to claim 1, wherein each configuration information comprises at least one of the following power control parameters:
target transmit power;
power compensation factor Alpha;
path loss (Pathloss) parameter;
power control loop;
power control command (TPC command); or
power control offset.

9. The transmit power determining method according to claim 1, wherein the uplink transmission comprises at least one of the following:
periodic uplink transmission or semi-persistent uplink transmission; or
dynamically scheduled uplink transmission.

10. The transmit power determining method according to claim 1, wherein when the uplink transmission is repeated transmission, the terminal performs any one of the following operations:
separately determining, by the terminal, a transmit power of each repetition based on the L pieces of configuration information and a resource in which each repetition is located; or
determining, by the terminal, transmit powers of all repetitions based on the L pieces of configuration information and a resource in which a Y^{th} repetition is located, wherein Y is greater than or equal to 1.

11. The transmit power determining method according to claim 1, wherein the receiving, by the terminal, the L pieces of configuration information sent by the network side device comprises:
receiving, by the terminal, Radio Resource Control (RRC) signaling sent by the network side device, wherein the RRC signaling comprises the L pieces of configuration information.

12. A transmit power determining method, comprising:
sending, by a network side device, L pieces of configuration information to a terminal, wherein the L pieces of configuration information comprise first power control configuration information or at least one piece of second power control configuration information; L is greater than or equal to 1; the first power control configuration information is used to determine a transmit power of the terminal for performing uplink transmission on a first uplink resource; each piece of the second power control configuration information is used to determine a transmit power of the terminal for performing uplink transmission on a second uplink resource; and the L pieces of configuration information indicate the terminal to determine a transmit power for performing uplink transmission on a target uplink resource.

13. The transmit power determining method according to claim 12, wherein a frequency domain resource unit of the first uplink resource satisfies at least one of the following:
the frequency domain resource unit of the first uplink resource does not overlap with any frequency domain resource unit in a transmission format of DL or flexible;
a frequency domain interval between the frequency domain resource unit of the first uplink resource and any frequency domain resource unit in the transmission format of DL or flexible is greater than or equal to N frequency domain resource units; or
a frequency domain interval between a center frequency of the first uplink resource and a center frequency of the frequency domain resource unit in the transmission format of DL or flexible is greater than or equal to N1 frequency domain resource units,
wherein a quantity or a granularity of the frequency domain resource unit of the first uplink resource is the same as or different from a quantity or a granularity of the frequency domain resource unit in the transmission format of DL or flexible.

14. The transmit power determining method according to claim 12, wherein a frequency domain resource unit of the second uplink resource satisfies at least one of the following:
the frequency domain resource unit of the second uplink resource overlaps with a frequency domain resource unit in a transmission format of DL or flexible;
the frequency domain resource unit of the second uplink resource does not overlap with the frequency domain resource unit in the transmission format of DL or flexible, and a frequency domain interval between the frequency domain resource unit of the second uplink resource and the frequency domain resource unit in the transmission format of DL or flexible is less than or equal to M frequency domain resource units; or
the frequency domain resource unit of the second uplink resource does not overlap with the frequency domain resource unit in the transmission format of DL or flexible, and a frequency domain interval between a center frequency of the second uplink resource and a center frequency of the frequency domain resource unit in the transmission format of DL or flexible is less than or equal to M1 frequency domain resource units,
wherein a quantity or a granularity of the frequency domain resource unit of the second uplink resource is the same as or different from a quantity or a granularity of the frequency domain resource unit in the transmission format of DL or flexible.

15. The transmit power determining method according to claim 12, wherein the second power control configuration information is related to at least one of the following:
a frequency domain interval between the frequency domain resource unit of the second uplink resource and a frequency domain resource unit in a transmission format of DL or flexible; or
a quantity of frequency domain resource units in the transmission format of DL or flexible and with a frequency domain interval from the frequency domain resource unit of the second uplink resource less than or equal to M frequency domain resource units.

16. The transmit power determining method according to claim 12, further comprising:
sending, by the network side device, indication information to the terminal,
wherein the indication information indicates at least one of the following:
configuration information corresponding to the target uplink resource; or
a transmission format.

17. The transmit power determining method according to claim 16, wherein the indication information comprises at least one of the following:
at least one resource set, wherein each resource set comprises at least one of the following: a time domain or frequency domain resource, a transmission format, target power control configuration information corresponding to the resource set, an uplink channel or an uplink signal corresponding to the resource set, a frequency domain interval from at least one frequency domain resource unit in a transmission format of DL, a frequency domain interval from at least one frequency domain resource unit in a transmission format of flexible, or a frequency domain interval between a center frequency of the resource set and a center frequency of the frequency domain resource unit in the transmission format of DL or flexible; or
at least one power adjustment indication, wherein each power adjustment indication comprises at least one of the following: target power control configuration information, an uplink channel or an uplink signal to which the target power control configuration information is applied, a resource set corresponding to the target power control configuration information, a frequency domain interval between an UL frequency domain resource unit to which the target power control configuration information is applicable and at least one frequency domain resource unit in a transmission format of DL, a frequency domain interval between the UL frequency domain resource unit to which the target power control configuration information is applicable and at least one frequency domain resource unit in the transmission format of flexible, or a frequency domain interval between a center frequency of the UL frequency domain resource unit to which the target power control configuration information is applicable and a center frequency of the frequency domain resource unit in the transmission format of DL or flexible.

18. The transmit power determining method according to claim 12, wherein each configuration information comprises at least one of the following power control parameters:
target transmit power;
power compensation factor Alpha;
path loss (Pathloss) parameter;
power control loop;
power control command (TPC command); or
power control offset.

19. The transmit power determining method according to claim 12, wherein the sending, by the network side device, the L pieces of configuration information to the terminal comprises:
sending, by the network side device, RRC signaling to the terminal, wherein the RRC signaling comprises the L pieces of configuration information.

20. A terminal, comprising a processor and a memory storing instructions, wherein the instructions, when executed by the processor, cause the processor to perform operations comprising:
receiving L pieces of configuration information sent by a network side device, wherein the L pieces of configuration information comprise first power control configuration information or at least one piece of second power control configuration information; L is greater than or equal to 1; the first power control configuration information is used to determine a transmit power of the terminal for performing uplink transmission on a first uplink resource; and each piece of the second power control configuration information is used to determine a transmit power of the terminal for performing uplink transmission on a second uplink resource; and
determining a transmit power for performing uplink transmission on a target uplink resource based on the L pieces of configuration information.
